(19) United States
(12) Patent Application Publication
(10) Pub. No.: US 2023/0337865 A1
(43) Pub. Date: Oct. 26, 2023

(54) Sink Drain Guard Sheet

(71) Applicant: Dezerey Banks, Dezeray, VA (US)

(72) Inventor: Dezerey Banks, Dezeray, VA (US)

(21) Appl. No.: 17/724,872

(22) Filed: Apr. 20, 2022

(51) Int. Cl. A47K 1/14; F16B 47/00

(52) U.S. Cl. CPC A47K 1/14; F16B 47/00

(57) ABSTRACT

Clean drains is the only product of its kind that is specifically developed to eliminate hair from falling down the drain and can be used on any and all sinks. This innovative and unprecedented product is uniquely designed with durable, high-quality materials to guarantee complete functionality and long term sustainability.

### BACKGROUND

When it comes to beauty care at home, often after brushing loose strands of hair over a bathroom sink, many individuals experience a clogged drain due to the collection of hair fragments. To address the issue in order to avoid pipe damage, individuals tend to use chemicals or have to invest in a mechanic to remedy the clogged drain which can be costly and time-consuming. There have been no products available as original equipment or as an aftermarket to address this problem.

An apparatus to help prevent clogged drains and easy clean-up of loose hairs that fall into the sink, is not being met by any known device or system at present. There have been no products available as original equipment or as an aftermarket to address this problem either.

### SUMMARY OF THE INVENTION

The main purpose of the sink drain guard sheet is to provide users with a plastic wipe off sheet that prevents hair from clogging bathroom sinks.

### BRIEF DESCRIPTION OF THE DRAWINGS

FIG. 1 is a top perspective view of the sink drain guard sheet in accordance with an embodiment of the present disclosure.

FIG. 2 is a top elevational view of a circular sink guard with underside ridge guides in accordance with an embodiment of the present disclosure.

FIG. 3 is a top elevational view of a rectilinear sink guard with rectilinear suction cups and multiple boarders in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

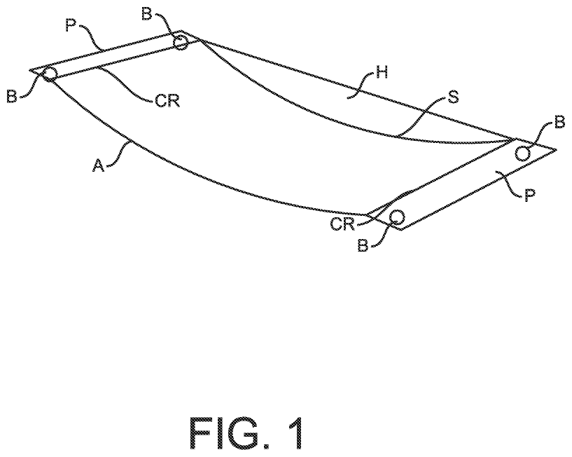

FIG. 1 is a top perspective view of the sink drain guard sheet showing: plastic wipe-off sheet referenced as A, suction cups referenced as B, bathroom sink referenced as C, perimeter or boarder P, sides H, and seam S which is elastic in embodiments in accordance with an embodiment of the present disclosure. A crease CR is a seam in embodiments of the sheet configured to provide a mechanical advantage to a resistance of the sheet to be sucked into the sink drain with a water flow there into.

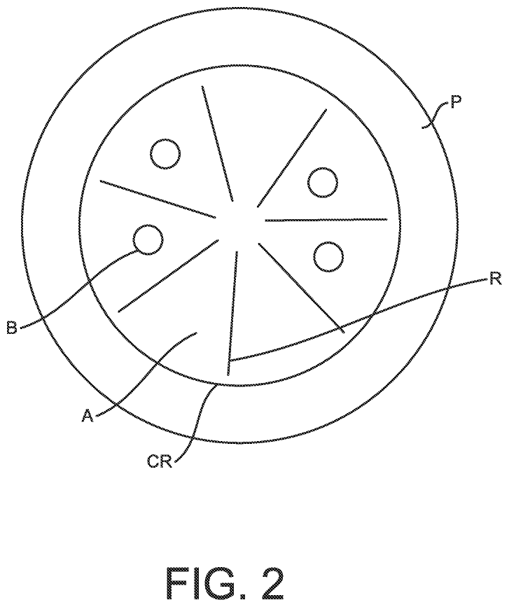

FIG. 2 is a top elevational view of a circular sink guard with underside ridge guides in accordance with an embodiment of the present disclosure. Limitations similar and same relative to FIG. 1 are referenced and ridges R on the underside of the sheet are configured to guide a water flow into or toward a drain of the sink. The suction cups B are randomly placed on an underside of the sheet to affix it to the surface of the sink. A crease CR is placed on the sheet to enable an overlap of the sheet with a rim of the sink and facilitate adhesion thereto.

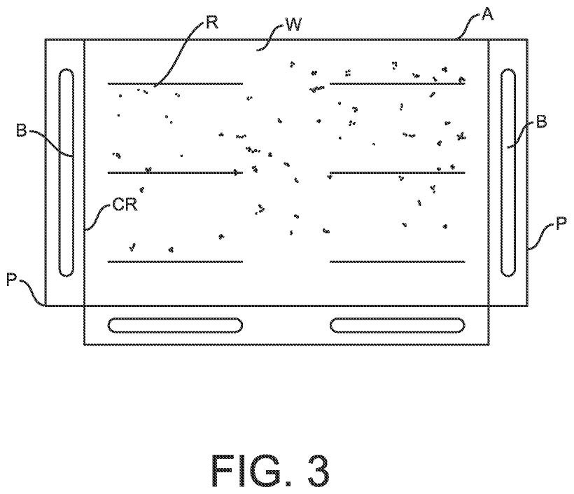

FIG. 3 is a top elevational view of a rectilinear sink guard with rectilinear suction cups and multiple boarders in accordance with an embodiment of the present disclosure. Limitations similar and same relative to FIG. 1 and FIG. 2 are depicted. A water permeable sheet W allows water to drain from the top side to the bottom side guided by ridges R on a bottom side or on a top side of the sheet. Multiple boarders P are depicted on three sides of the rectilinear sheet in order to stretch the sheet taunt over the sink and over the drain thereof. Suction cups B are also rectilinear to further attache the sheet to the sink. A perforation similar to W also allows additional water passage from the topside into the sink drain and filter hair and dandruff and debries from the sink drain.

The present disclosed sink drain guard sheet, also known as “Clean Drains” offers a simple, quick, and effective solution that ensures bathroom sinks are clear of hair as a preemptive means to prevent both sink damage and clogging. Meant to complement an average sink design, dean drains introduces a novel plastic wipe off sheet with suction cups, four positioned on each end, that can be easily placed over a bathroom sink. After clean drains is in position, the platform serves to catch any loose hair that has fallen during the combing or styling process. Once users are done, they simply remove the sheet, slide the collected hair into the garbage, wipe clean drains off with a napkin, and store it for use, when needed. As a result, individuals will no longer have to deal with the tedious and inconvenient sink unclogging process, and will be able to reduce plumbing costs. Clean drains ensures a fully operational hygienic platform that may benefit all individuals who seek to have an effective solution to thwarting sink clogging.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A sink guard comprising:
a sheet comprising an underside and a topside; and
a suction cup attached to the underside of the sheet and configured to fix the sheet in a relative placement to the sink.

2. The sink guard of claim 1, wherein the sheet comprises a water permeable perforation.

3. The sink guard of claim 1, wherein the sheet is rectilinear and matches a rectilinear shape of the sink.

4. The sink guard of claim 1, wherein the sheet is circular and matches a circular shape of the sink.

5. The sink guard of claim 1, wherein the sheet is rectilinear and a suction cup is disposed at each corner of the sheet.

6. The sink guard of claim 1, wherein the sheet is circular and a plurality of suction cups are disposed proximal a perimeter thereof.

7. The sink guard of claim 1, further comprising the sheet having a surface area larger than a surface area of the sink.

8. The sink guard of claim 1, further comprising a border on the sheet, the border configured to overlay a ledge of the sink.

9. The sink guard of claim 1, further comprising a border on the sheet configured to receive a plurality of suction cups.

10. The sink guard of claim 1, wherein the suction cup is rectilinear.

11. The sink guard of claim 1, wherein the suction cup is rectilinear and a plurality of rectilinear suction cups are disposed on the underside of the sheet.

12. The sink guard of claim 1, wherein a plurality of suction cups are distributed randomly on the underside of sheet.

13. The sink guard of claim 1, wherein the bottom side of the sheet comprises ridges.

14. The sink guard of claim 1, wherein the bottom side of the sheet comprises ridges leading toward a central drain thereof.

15. The sink guard of claim 1, wherein the top side of the sheet comprises a slippery coating configured to pass strands of hair therefrom.

16. The sink guard of claim 1, further comprising a boarder of the sheet configured to stretch taunt from a rim of the sink across a drain thereof.

17. The sink guard of claim 1, wherein the sheet is configured to be draped on a surface of the sink across a drain thereof.

18. The sink guard of claim 1, further comprising a crease between the sheet and a boarder of the sheet, the crease configured to bend at a rim of the sink.

19. The sink guard of claim 1, further comprising a plurality of sides attached to the sheet and configured to match a half dome shape of the sink.

20. The sink guard of claim 1, further comprising an elastic seam in the sheet configured to enable a drag of the sheet to match a shape of the sink.
